(19) United States
(12) Patent Application Publication
(10) Pub. No.: US 2010/0127440 A1
(43) Pub. Date: May 27, 2010

(54) Damping Device Capable of Decreasing Torsional Vibration

(75) Inventor: Hong Suk CHANG, Gyunggi-City (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/508,250

(22) Filed: Jul. 23, 2009

(30) Foreign Application Priority Data
Nov. 24, 2008 (KR) 10-2008-0116846

(51) Int. Cl. F16F 13/00

(52) U.S. Cl. 267/140.12

(57) ABSTRACT

A damping device that is capable of decreasing torsional vibration may include a driving element and a driven element spaced apart from each other, a receiving groove being shaped as an oval formed along a circular path with a given radius about an axis thereof and formed at the driving element, a carrier which is disposed at the driven element and disposed inside the receiving groove so as to contact an inner part thereof, and a magnetic substance disposed at the carrier, and wherein both sides of the receiving groove are provided with a repulsive force on the magnetic substance in a direction of the center of the receiving groove.

### CROSS-REFERENCE TO RELATED APPLICATION

The present application claims priority to Korean Patent Application No. 10-2008-0116846 filed on Nov. 24, 2008, the entire contents of which are incorporated herein for all purposes by this reference.

### BACKGROUND OF THE INVENTION

1. Field of the Invention

The present invention relates to a damping device, and more particularly to a damping device that is capable of decreasing torsional vibration with damping action through repulsive force and contacting a surface intermittently therewith when acceleration from a crankshaft to a nose portion occurs.

2. Description of Related Art

Generally, whenever a crankshaft is rotated, a torsional vibration or bending vibration occurs.

The greater the rotating force of the crankshaft and the longer the length of the crankshaft, or the lower the hardness of the crankshaft, the greater the torsional vibration.

The torsional vibration causes natural and sympathetic vibration about the crankshaft in the case of exceeding a predetermined rotational speed, and it results in deteriorating ride comfort by extreme vibration, and it damages a timing gear or the crankshaft.

In order to solve the above problem, a damper pulley that is provided with rubber between an exterior surface of a hub and an interior surface of a ring is used at a front end of the crankshaft, and a separate ring is inserted to the exterior surface of the hub and thereby the length of an engine is long.

The vibration is absorbed by the rubber disposed between the hub and the ring in the damper pulley.

When the rotational speed of the crankshaft is constant, the hub is rotated integrally with the crankshaft, however, when the crankshaft generates torsional vibration, the ring tends to rotate continually in a constant speed, and thereby the vibration is reduced by deformation of the rubber disposed therebetween.

Such a pulley may be a single mass damper pulley, an isolated damper pulley, etc.

In addition, a double mass damper pulley as a damper pulley is provided with dual belt grooves, and is provided with an outer ring/inner ring at an exterior/interior surface of a hub, such that it forms a dual mode damper pulley.

Although the single mass damper pulley is a simple structure that is manufactured easily, the damping is deteriorated at a high speed of the engine.

Further, in spite of an advantage of having damping performance of the isolated damper pulley, it is too expensive and complex to manufacture easily in comparison with the above.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a damping device that is capable of decreasing torsional vibration having advantages of damping by repulsive force generated from a magnetic substance in an operating state, damping only by a repulsive force in a high load state, and damping smoothly by intermittent surface contact between a surface of a receiving groove and that of a carrier.

In an aspect of the present invention, the damping device that is capable of decreasing torsional vibration, may include a driving element and a driven element coaxially coupled each other and spaced apart from each other in an axial direction thereof; a receiving groove formed in the driving element, wherein the receiving groove is shaped as an oval and formed along a circular path with a predetermined radius about a rotational axis thereof; a carrier that is formed on the driven element, and slidably disposed inside the receiving groove of the driving element so as to selectively contact an inner part of the receiving groove according to rotation speed of the driving element; and a first magnetic substance disposed in the carrier, wherein both sides of the receiving groove are provided with a repulsive force acting on the first magnetic substance of the carrier toward a center direction of the receiving groove.

The first magnetic substance may be divided into S-pole and N-pole respectively approximately by half, and both distal sides of the oval shape of the receiving groove facing the first magnetic substance may include a second magnetic substance having the same magnetic polarity respectively with respect to a facing surface of the first magnetic substance.

A plurality of the receiving grooves may be provided along the circular path of the driving element and a plurality of the carries formed on the driven element is slidably received therein.

The first magnetic substance may be formed of a rubber magnet.

The carrier may be further enclosed by at least one layer of rubber materials having different hardness respectively, wherein the at least one layer of the rubber material is a sponge-type rubber material formed of bubbles. The carrier may be enclosed by a sponge-type rubber material formed of bubbles.

The receiving groove and the first magnetic substance may be spaced apart from each other in a circumferential direction thereof under one predetermined load condition, and the first magnetic substance contacts a surface of the receiving groove in a rotating direction thereof by a torque exceeding the repulsive force therebetween under another predetermined load condition.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a cross-sectional view showing a damping device according to various embodiments of the present invention.

FIG. 2 is a front view showing a damping device according to various embodiments of the present invention.

FIG. 3A shows an operation relationship of permanent magnets therebetween in a no load state of a damping device according to various embodiments of the present invention.

FIG. 3B shows an operation relationship of permanent magnets therebetween in a low load state of a damping device according to various embodiments of the present invention.

FIG. 3C shows an operation relationship of permanent magnets therebetween in a high load state of a damping device according to various embodiments of the present invention.

FIG. 4A is a schematic view of a damping device according to another exemplary embodiment of the present invention in a no-load state.

FIG. 4B is a schematic view of a damping device according to another exemplary embodiment of the present invention in a low load state.

FIG. 4C is a schematic view of a damping device according to another exemplary embodiment of the present invention in a high load state.

FIG. 5 is a graph showing experimental results of a damping device according to another exemplary embodiment of the present invention.

FIG. 6A is a schematic view of a damping device according to a further exemplary embodiment of the present invention.

FIG. 6B is a graph showing experimental results of a damping device according to a further exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

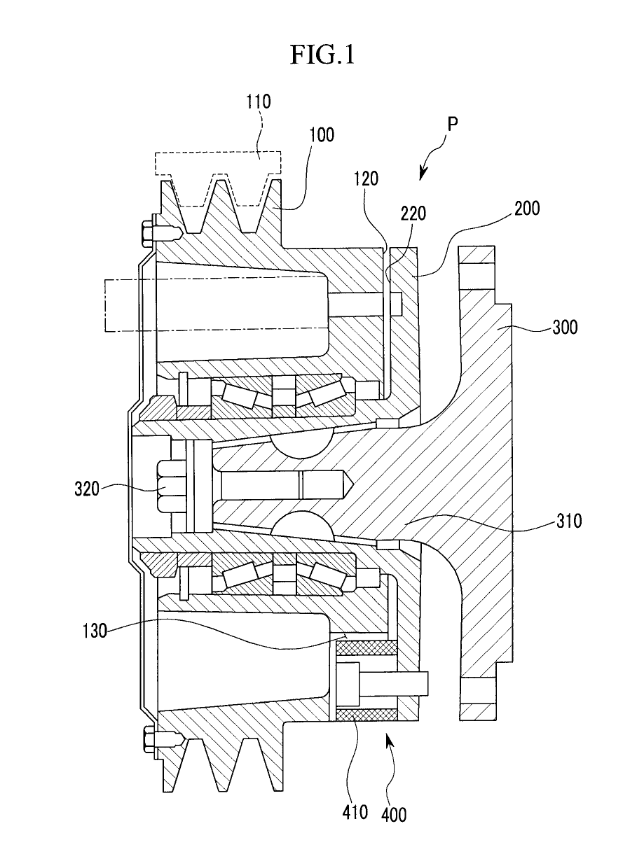

FIG. 1 is a cross-sectional view showing a damping device according to an exemplary embodiment of the present invention.

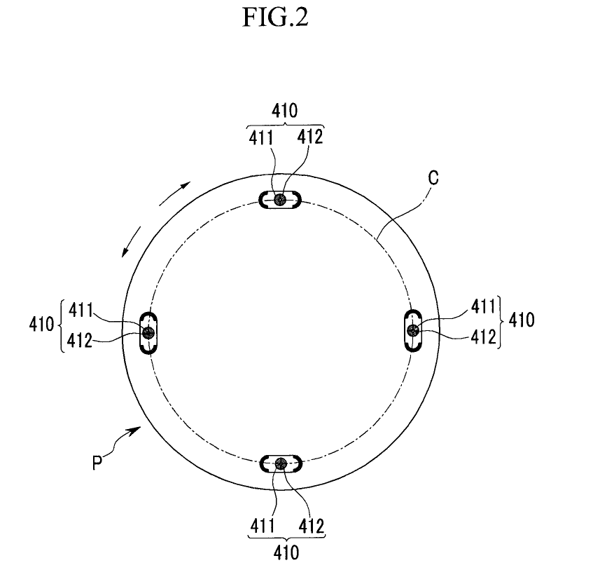

FIG. 2 is a front view showing a damping device according to an exemplary embodiment of the present invention.

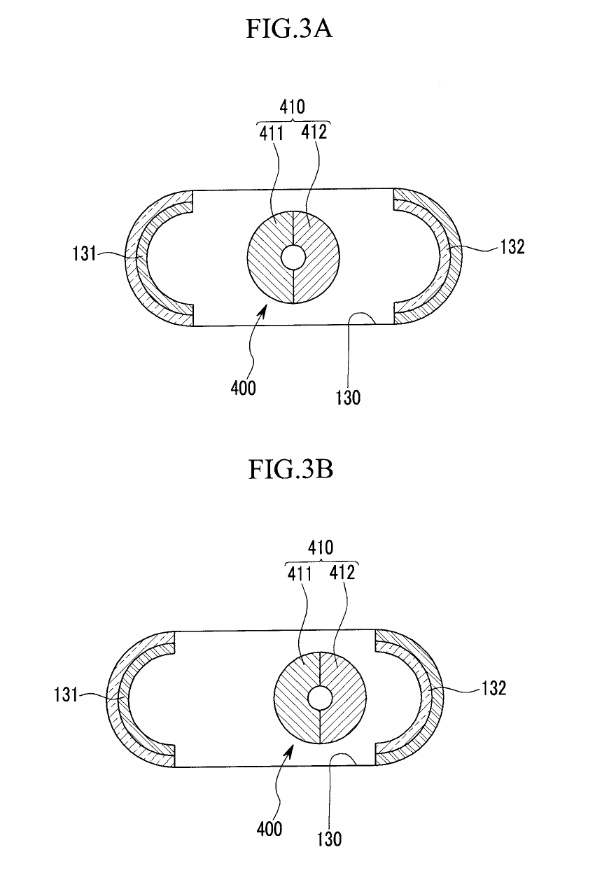

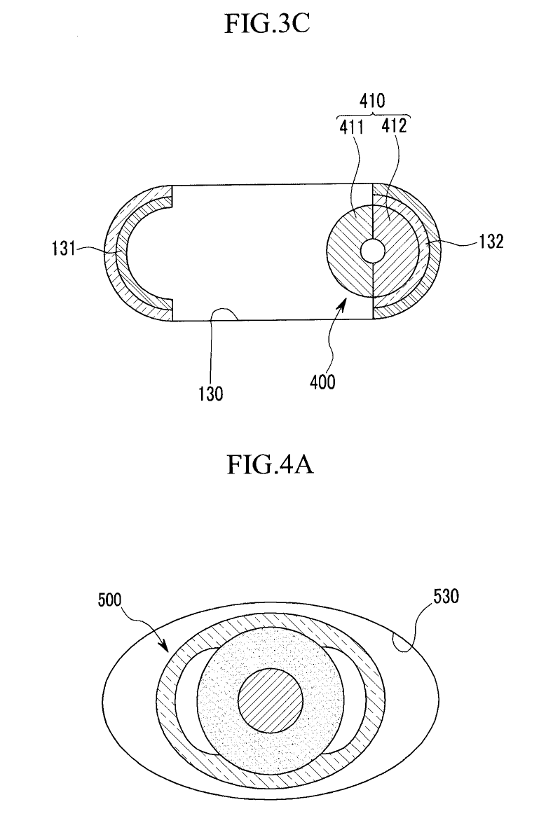

FIG. 3A shows an operation relationship of permanent magnets therebetween in a no load state of a damping device according to an exemplary embodiment of the present invention.

FIG. 3B shows an operation relationship of permanent magnets therebetween in a low load state of a damping device according to an exemplary embodiment of the present invention.

FIG. 3C shows an operation relationship of permanent magnets therebetween in a high load state of a damping device according to an exemplary embodiment of the present invention.

As shown in FIG. 1, a damping device according to an exemplary of the present invention is driven by a belt 110 of a driving element 100.

The damping device is disposed at a driving device, a compressor of an air conditioner, or a generator.

The damping device includes a driving element 100 and a driven element 200.

The driving element 100 and the driven element 200 are rotated on a rolling bearing various embodiments of the present invention, and the like.

The driven element 200 is provided with a flange 300 and is penetrated by a driving shaft various embodiments of the present invention.

The driven element 200 and the flange 300 are simultaneously rotated through a clamping cone 310.

In this case, the flange 300 is clamped with a clamping screw 320 formed at the end of the clamping cone 310.

Further, the driven element 200 faces the driving element 100 such that flange surfaces 120 and 220 are apart from each other and confront each other with a predetermined distance therebetween.

The flange surfaces 120 and 220 are substantially perpendicular to a rotating shaft of a pulley device P and the flange 300.

In addition, a carrier 400 is formed at a circular path C having a smaller radius than a radius of the driven element 200.

The carrier 400 is fixed to the circular path C by bolts, etc., and a magnetic substance 410 is formed at a circumference of the carrier 400.

Herein, the magnetic substance 410 may be a rubber magnet that is capable of selectively forming an S-pole or an N-pole.

Further, it is preferable that the shape of the magnetic substance 410 is cylindrical in order to smoothly contact a receiving groove 130.

The magnetic substance 410 is formed such that an S-pole 411 and an N-pole 412 respectively occupy half of the magnetic substance 410.

Further, a space is defined by the driving element 100 such that the carrier 400 is snugly inserted thereto.

Thus, the receiving groove 130 is formed at the driving element 100 such that the S-pole 411 and N-pole 412 face each other.

Referring to FIG. 2, although four receiving grooves 130 are shown along the circular path C, the number of receiving grooves 130 can be more than four.

In addition, it is preferable that each receiving groove 130 is spaced apart from an exterior circumference of the magnetic substance 410 by a predetermined distance such that the magnetic substance 410 is snugly disposed inside the receiving groove 130 that has a shape corresponding to that of the magnetic substance 410, and further, it is necessary that the radius and area of the receiving groove 130 are greater than those of the magnetic substance 410.

Also, surfaces of the receiving groove 130 respectively confronting the S-pole and N-pole may have the same poles formed as rubber, etc.

That is, the N-pole 412 of the carrier 400 is provided to face an N-pole 132 of the receiving groove 130, and the S-pole 411 of the carrier 400 is provided to face an S-pole 131 of the receiving groove 130.

Therefore, when the driving element 100 is rotated in a direction, the driven element 200 is rotated by a repulsive force caused by magnetic force occurring between the carrier 400 and the receiving groove 130.

At this time, if a torque exceeding the repulsive force generated between the carrier 400 and the receiving groove 130 is exerted, the carrier 400 contacts a surface of the receiving groove 130 toward a rotating direction of the carrier 400.

Thus, in an idle state as shown in FIG. 3, the magnetic substance 410 formed at the carrier 400 disposed inside the receiving groove 130 is spaced apart from the S-pole 131 and the N-pole 132 formed at the receiving groove 130 by the repulsive force.

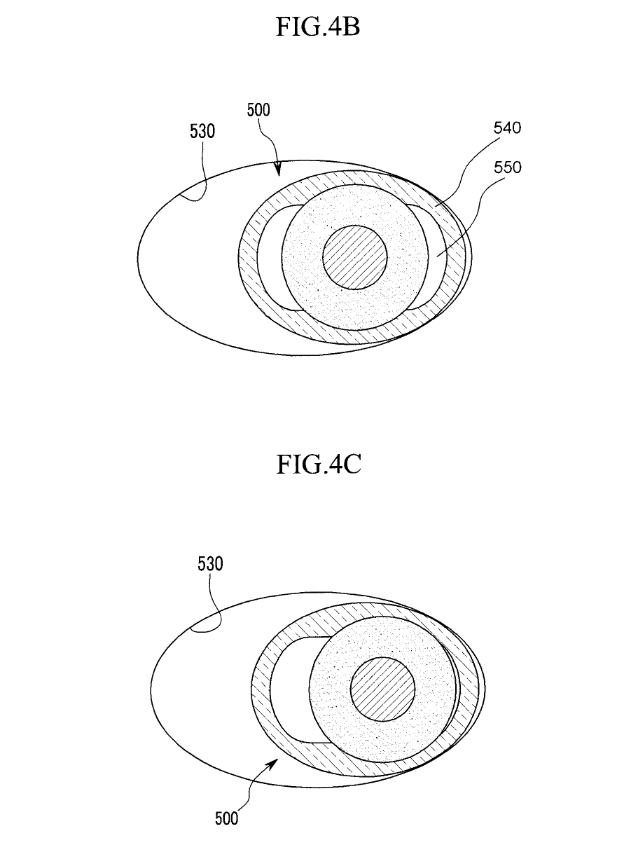

Further, as shown in FIG. 4, the carrier 400 is biased by an amount of force exceeding the repulsive force generated between the carrier 400 and the receiving groove 130.

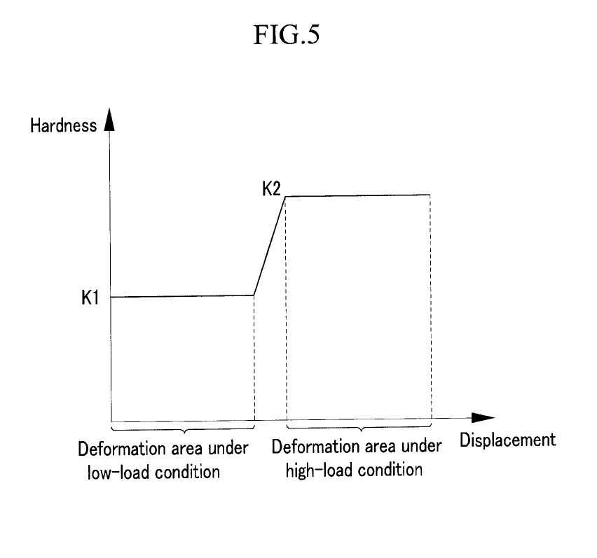

Meanwhile, in a high load state as shown in FIG. 5, since torque of the carrier 400 about a rotating direction exceeds a repulsive force generated between the carrier 400 and the receiving groove 130, a surface of the carrier 400 contacts a surface of the receiving groove 130.

Therefore, in a low load state, a power is transmitted by the repulsive force generated between the carrier 400 and the receiving groove 130, while in a high load state, the power is transmitted by a contacting force generated therebetween with being supported elastically.

FIG. 4A through FIG. 4C are cross-sectional views of a carrier formed of rubber materials respectively in no-load condition, a low load condition, and a high load condition.

The carrier 500 formed of rubber materials may be made of two or more rubber materials having different hardness in order to form a multiple-hardness material.

As shown in FIG. 4A, the carrier 500 is maintained in such a state that the carrier 500 does not contact the receiving groove 530.

And, as shown in FIG. 4B, an outer rubber 540 of the carrier 500 contacts the receiving groove 530 so as to receive a portion of a load under a low load condition.

Further, as shown in FIG. 4C, an inner rubber 550 formed inside the outer rubber 540 of the carrier 500 receives a load under a high load condition.

FIG. 5 is a graph showing experimental results of the case in which the two rubbers have different hardness.

That is, as shown in FIG. 5, change of deformation of the carrier is discontinuous, and it is divided into a low load condition area and a high load condition area.

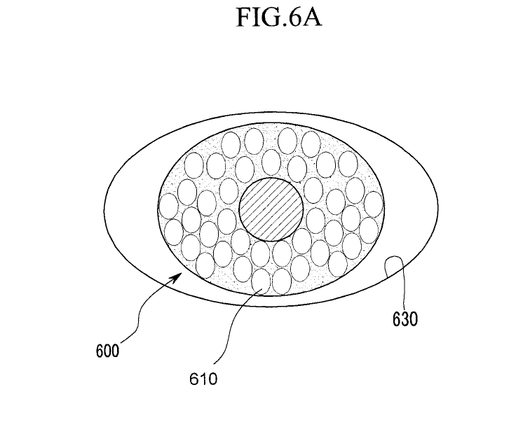

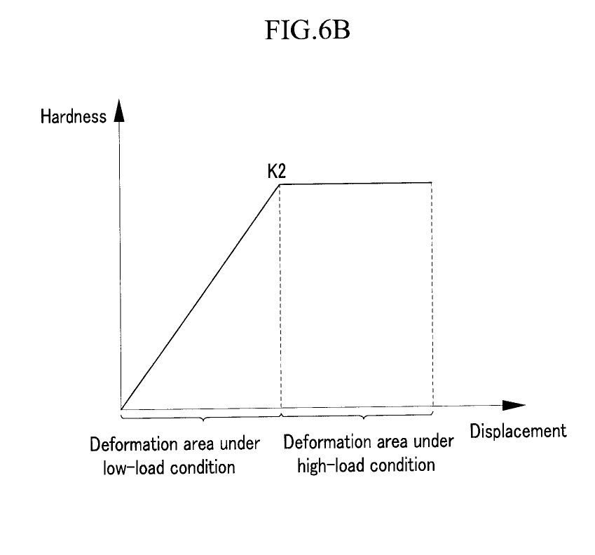

Meanwhile, as shown in FIG. 6A, a carrier 600 may be made of a sponge-type rubber having bubbles 610 therein.

Referring to FIG. 6B, conversion between a low load condition and a high load condition is smooth through a continuous increase of hardness because of the bubbles 610 inside the receiving groove 630 of the carrier 600.

Since the carrier is desirably operable only through changing the material thereof without the S-pole and N-pole as a magnetic member, manufacturing cost thereof can be reduced.

For convenience in explanation and accurate definition in the appended claims, the terms “interior”, “exterior”, “inner”, and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A damping device that is capable of decreasing torsional vibration, comprising:
a driving element and a driven element coaxially coupled each other and spaced apart from each other in an axial direction thereof;
a receiving groove formed in the driving element, wherein the receiving groove is shaped as an oval and formed along a circular path with a predetermined radius about a rotational axis thereof;
a carrier that is formed on the driven element, and slidably disposed inside the receiving groove of the driving element so as to selectively contact an inner part of the receiving groove according to rotation speed of the driving element; and
a first magnetic substance disposed in the carrier, wherein both sides of the receiving groove are provided with a repulsive force acting on the first magnetic substance of the carrier toward a center direction of the receiving groove.

2. The damping device of claim 1, wherein the first magnetic substance is divided into S-pole and N-pole respectively approximately by half, and both distal sides of the oval shape of the receiving groove facing the first magnetic substance includes a second magnetic substance having the same magnetic polarity respectively with respect to a facing surface of the first magnetic substance.

3. The damping device of claim 1, wherein a plurality of the receiving grooves are provided along the circular path of the driving element and a plurality of the carries formed on the driven element are slidably received therein.

4. The damping device of claim 1, wherein the first magnetic substance is formed of a rubber magnet.

5. The damping device of claim 1, wherein the carrier is further enclosed by at least one layer of rubber materials having different hardness respectively.

6. The damping device of claim 5, wherein the at least one layer of the rubber material is a sponge-type rubber material formed of bubbles.

7. The damping device of claim 1, wherein the carrier is enclosed by a sponge-type rubber material formed of bubbles.

8. The damping device of claim 1, wherein the receiving groove and the first magnetic substance are spaced apart from each other in a circumferential direction thereof under one predetermined load condition, and the first magnetic substance contacts a surface of the receiving groove in a rotating direction thereof by a torque exceeding the repulsive force therebetween under another predetermined load condition.
